(19) United States
(12) Patent Application Publication
(10) Pub. No.: US 2025/0148557 A1
(43) Pub. Date: May 8, 2025

(54) REAL ESTATE LISTING EVALUATION ENGINE

(71) Applicant: FEVR LLC, Scottsdale, AZ (US)

(72) Inventors: James Kwon Lee, Scottsdale, AZ (US); Naveen Prabakar, Los Angeles, CA (US)

(73) Assignee: FEVR LLC, Scottsdale, AZ (US)

(21) Appl. No.: 18/502,341

(22) Filed: Nov. 6, 2023

(51) Int. Cl. G06Q 50/16

(52) U.S. Cl. CPC G06Q 50/163

(57) ABSTRACT

Disclosed are some implementations of systems, apparatus, methods and computer program products for implementing a real estate listing description analysis engine. The engine can generate a summary of a description or a new description based upon analysis of the description.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to systems and techniques for evaluating listings associated with property. More particularly, this patent document relates to a machine learning model assisted real estate listing engine.

### BACKGROUND

Real estate listings with a real estate service such as the Multiple Listing Service (MLS) require a property description to be submitted. The content of the property description is often a key factor in the success of a real estate listing. Unfortunately, there has not been an objective means for assessing the quality of the property description.

### BRIEF DESCRIPTION OF THE DRAWINGS

The included drawings are for illustrative purposes and serve only to provide examples of possible structures and operations for the disclosed systems, apparatus, methods and computer program products for facilitating real estate listing analysis and generation. These drawings in no way limit any changes in form and detail that may be made by one skilled in the art without departing from the spirit and scope of the disclosed implementations.

FIG. 1 shows a system diagram of an example of a system 100 configured to facilitate the analysis of real estate listing descriptions, in accordance with some implementations.

FIG. 2 shows an example of listing descriptions that can be processed, in accordance with some implementations.

FIG. 3 shows example categories of real estate listings used to train a supervised learning model, in accordance with some implementations.

FIG. 4 shows a diagram illustrating an example system 108 that can analyze real estate property descriptions, in accordance with some implementations.

FIG. 5 shows a diagram illustrating an example method of processing real estate descriptions 500, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Real estate listings with a real estate service such as the Multiple Listing Service (MLS) require a property description to be listed. Unfortunately, the description may contain spelling or other errors. These errors can impact the likelihood that a listed property will sell, as well as the time it takes for the listed property to sell.

Furthermore, various characteristics of the property description such as the words used to describe the property can impact the success or failure of a real estate listing. In accordance with various implementations, a system trains a machine learning model to score a real estate property's listing description. In the following disclosure, the property is a real estate property. However, it is important to note that these examples are merely illustrative. Thus, in other implementations, the property can be commercial real estate or a vehicle such as an aircraft or seacraft.

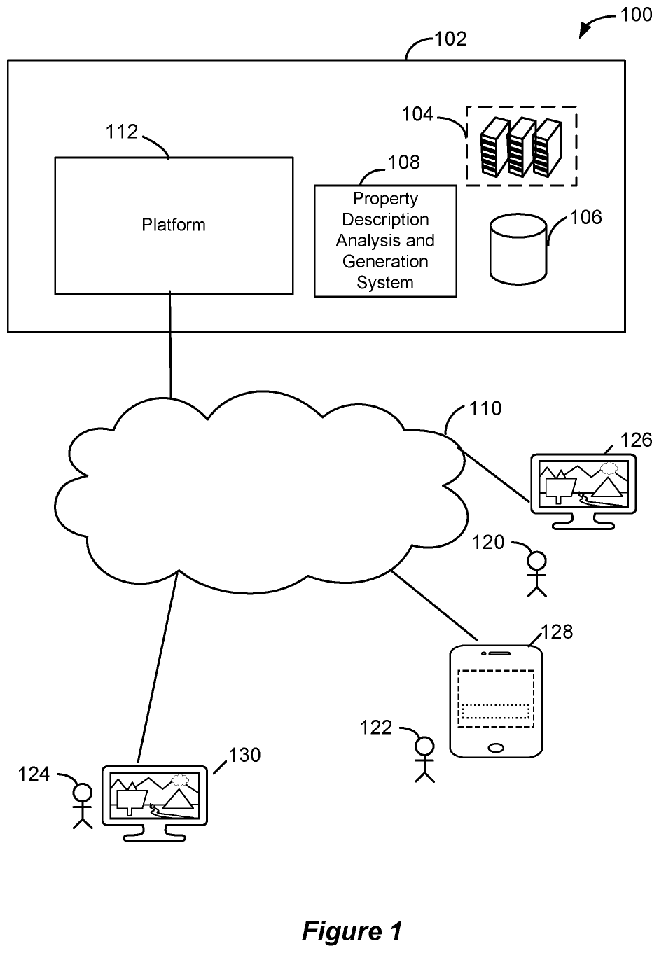

FIG. 1 shows a system diagram of an example of a system 100 configured to facilitate the analysis of real estate property descriptions, in accordance with some implementations. Database system 102 includes a variety of different hardware and/or software components that are in communication with each other. In the example of FIG. 1, system 102 includes any number of computing devices such as servers 104. Servers 104 are in communication with one or more storage mediums 106 configured to store and maintain relevant data and/or metadata used to perform some of the techniques disclosed herein, as well as to store and maintain relevant data and/or metadata generated or transmitted by the techniques disclosed herein. Storage mediums 106 may further store computer-readable instructions configured to perform some of the techniques described herein.

System 102 includes server system 108, as described herein. More particularly, server system 108 supports the analysis of real estate property descriptions and automated generation of real estate property descriptions, as described herein.

Client devices 126, 128, 130 may be in communication with system 102 via network 110. More particularly, client devices 126, 128, 130 may communicate with server system 108 via network 110. For example, network 110 can be the Internet. In another example, network 110 comprises one or more local area networks (LAN) in communication with one or more wide area networks (WAN) such as the Internet.

Embodiments described herein are often implemented in a cloud computing environment, in which network 110, servers 104, and possible additional apparatus and systems such as multi-tenant databases may all be considered part of the “cloud.” Servers 104 may be associated with a network domain and may be controlled by a data provider associated with the network domain. In this example, users 120, 122, 124 of client computing devices 126, 128, 130 access a web site to analyze a property description. In some implementations, users 120, 122, 124 can initiate automated generation of a property listing description. Examples of devices used by users include, but are not limited to, a desktop computer or portable electronic device such as a smartphone, a tablet, a laptop, etc.

In some implementations, users 120, 122, 124 of client devices 126, 128, 130 can access services provided by system 102 via platform 112 or an application installed on client devices 126, 128, 130. More particularly, client devices 126, 128, 130 can access system 102 via an application programming interface (API) or via a graphical user interface (GUI) using credentials of corresponding users 120, 122, 124 respectively. Client devices 126, 128, 130 can communicate with system 102 via platform 112. Communications between client devices 126, 128, 130 and system 102 can be initiated by a user 120, 122, 124. Therefore, communications between client devices 126, 128, 130 and system 102 can be initiated responsive to a user request.

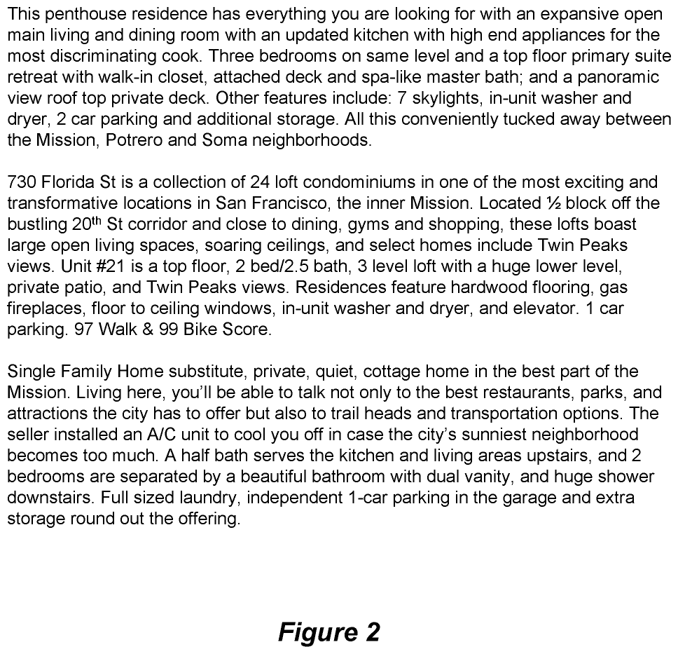

FIG. 2 shows an example of listing descriptions that can be processed, in accordance with some implementations. As shown in this example, the listing descriptions may be of varying lengths. Each listing may include any number of sentences or words. The listing descriptions can be retrieved from a multiple listing service (MLS) or other service (e.g., web site).

A listing can include words that convey a sentiment. More particularly, words conveying a positive sentiment may include words such as “great,” “spacious,” “large,” and “soaring,” while words conveying a negative sentiment may include words such as “tiny,” “cozy,” and “pied-a-terre.” More particularly, a negative sentiment can include words that convey that the property is small. Words conveying a positive sentiment can include words that imply that the property is large and spacious. In some implementations, the inclusion of a walk score is interpreted as a positive sentiment.

In some implementations, the training data is used to train a semi-supervised learning model. In other implementations, the training data is used to train a supervised learning model.

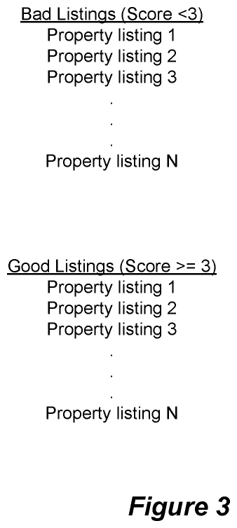

FIG. 3 shows example categories of real estate listings used to train a supervised learning model, in accordance with some implementations. In this example, a first group of property listing descriptions is assigned a first label while a second group of property listing descriptions is assigned a second label. For example, a first label may be “good,” while a second label may be “bad.” Each of the first group of descriptions may have an assigned score between a first minimum and first maximum (e.g., between 1 and 3), and each of the second group of descriptions may have an assigned score between a second minimum and second maximum (e.g., between 3 and 5). A normalization formula may be applied to normalize the scores.

In some implementations, one or more scores may be assigned to a property listing description in the training data based, at least in part, on objective data such as a number of days the real estate property was on the market prior to selling and/or a number of users that have saved the description prior to sale of the property.

For example, a listing that was on the market 7 days prior to selling and for which the listing was saved by 9 users may be assigned a score of 4.8 while another listing that sold after 30 days on the market and saved by 2 users may be assigned a score of 1.2.

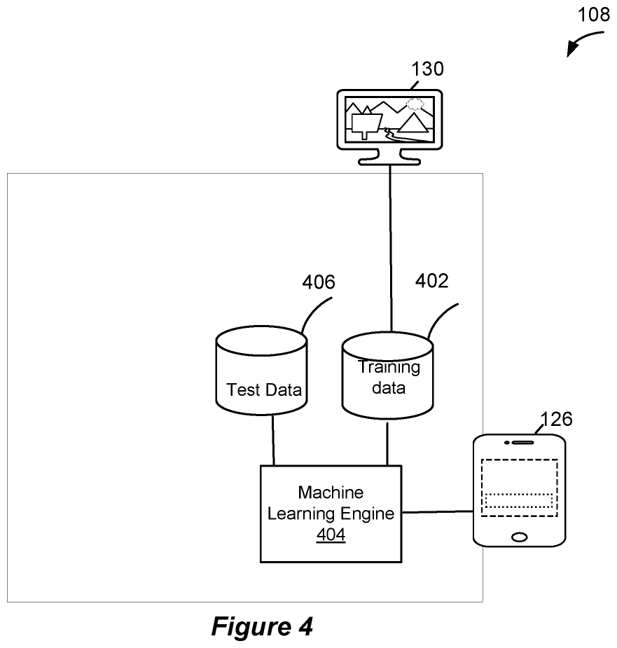

FIG. 4 shows a diagram illustrating an example system 108 that can analyze real estate property descriptions, in accordance with some implementations. As shown in this example, a user may access client device 130 to input training data 402 that is processed by a machine learning engine 404 configured to train a machine learning model, as described herein. Once trained, test data 406 may be input to test the machine learning model. For example, an Application Programming Interface (API) call can retrieve the test data 406.

In some implementations, training data 402 is obtained from the entire property listing description. In other implementations, training data 402 is obtained from a subset of the property listing description. For example, the first two lines may be processed to extract words used within the description.

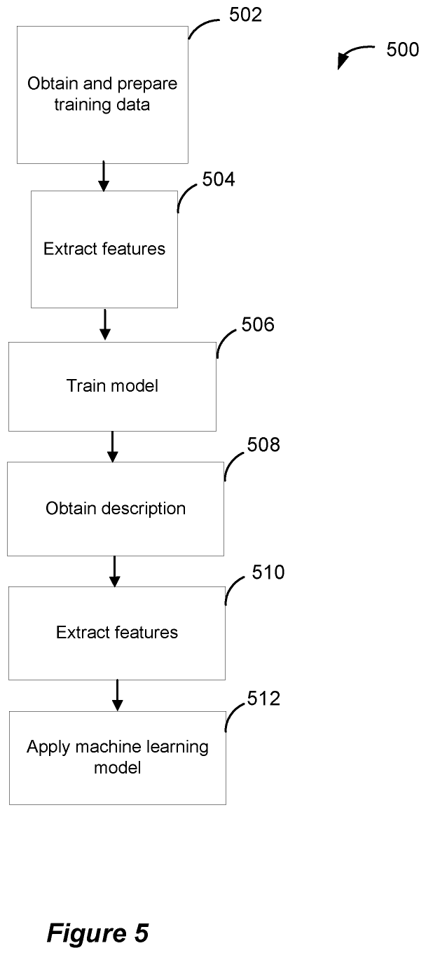

FIG. 5 shows a diagram illustrating an example method of processing real estate descriptions 500, in accordance with some implementations. The system obtains training data at 502, the training data including a plurality of descriptions, each of the plurality of descriptions describing a corresponding property. More particularly, the property may include a real estate property, commercial real estate, or a vehicle such as a sea vehicle or airplane.

The training data may be pre-processed to prepare the training data. For example, duplicate descriptions may be removed from the training data by identifying listings for the same address. As another example, characters such as special characters and/or white spaces may be removed. Text of the training data may be further pre-processed via tokenization.

The system may extract at 504 from the training data, for each of a plurality of features, at least one corresponding feature value of a first plurality of feature values. More particularly, text-based features may be extracted while remaining features may be determined, as described herein. Examples of features of descriptions include a grammatical mistake count, a good words count, a bad words count, a feature words count (e.g., bedrooms, bathrooms, A/C, laundry), a descriptive adjective count, sentiment, description length, capital letter count, sentence count, average sentence length, punctuation count, numerical digit count, special character count, readability score (e.g., number of syllables per sentence), and/or read time in minutes.

Features can also further include SEO optimization and n-gram vectorization. For example n-gram vectorization can include a document term matrix, where each cell represents the count, while SEO optimization can include keywords used in the description. In some implementations, the SEO optimization is obtained from the first two lines of the description while the remaining features are obtained from the entire description.

In some implementations, the features include a grammatical mistake count specifying the number of grammatical errors in the description. Grammatical errors can include misspelled words or missing words. The features can further include a good words count and/or a bad words count. The good words count specifies the number of words that are considered “good” or exhibiting a positive sentiment; bad words specifies the number of words that are considered “bad” or exhibiting a negative sentiment. More particularly, “good” words are words that real estate professionals deem to be positive when incorporated into a listing description while “bad” words are words that real estate professionals deem to be negative when incorporated into a listing description.

In some implementations, a first word dictionary identifies words that are considered bad while a second word dictionary identifies words that are considered good. For each word in the description, the word is searched in at least one of the dictionaries. If it is found in one dictionary, the second dictionary need not be searched for the word. However, if the word is not found in one dictionary, the second dictionary can be searched for the word.

A feature words count can specify the number of real estate features identified or described in a given description. For example, feature words can include the words “bedrooms,” “bathrooms,” “A/C,” and/or “parking.” A feature words dictionary may identify possible feature words that can be found in a real estate listing. The number of instances of feature words may be determined by searching the feature words dictionary for words in the description.

In addition, a descriptive adjective count can specify the number of adjectives within the description. To identify adjectives, an adjective dictionary may be searched for words in the description.

A sentiment feature identifies the overall sentiment expressed in the description. The overall sentiment may be determined by searching one or more sentiment dictionaries for words in the description. More particularly, a positive sentiment dictionary may identify positive words while a negative sentiment dictionary may identify negative words. For example, a positive sentiment dictionary may identify words such as “great” and “fabulous.” As another example, a negative sentiment dictionary may identify words or phrases such as “price reduced.”

A description length may be expressed in terms of number of words in the description. Similarly, a capital letter count specifies the number of capital letters in the description. Sentence count indicates or specifies the number of sentences in the description.

An average sentence length specifies the average number of words in the sentences of the description. Punctuation count specifies the number of times a punctuation mark is found in the description. A numerical digit count specifies the number of times a numerical digit is found in the description. A special character count specifies the number of times special characters such as $. %, and @ are found in the description.

A readability score specifies a score indicating the readability of the description. More particularly, readability may be determined based upon the number of syllables in the description or number of syllables per sentence of the description.

The features can further include a read time in minutes. The read time can be a factor of the number of sentences in the description or number of words in the description. For example, the read time can indicate the number of minutes assuming a reading speed of 120 words a minute.

The system trains a machine learning model at 506 using the first plurality of feature values corresponding to the plurality of features, the machine learning model including a plurality of coefficients, each coefficient corresponding to one of the plurality of features. The coefficients may also be referred to as weights.

Training the machine learning model may be accomplished by performing semi-supervised learning. Alternatively, supervised learning may be performed.

For example, the training data can include two different categories of data. A first group of descriptions may be assigned a first label (e.g., bad) and a second group of descriptions may be assigned a second label (e.g., good). More particularly, each description of the first group of descriptions may have an assigned score between 1 and 3, while each description of the second group of descriptions may have an assigned score between 3 and 5. A description of a property in the training data may be assigned a score or label based, at least in part, on number of days the property is on the market prior to selling and/or a number of users that have saved the description. For example, a good property may be a property that sells within 7 days while a bad property may be a property that sells after 30 days.

Subsequently, data including a description of a property is obtained at 508. This data can include test data or a specific description of interest. More particularly, an API may be called to obtain the test data.

The description may be pre-processed to remove special characters and white spaces. The system then extracts at 510 for the description, for each of the plurality of features, a corresponding one of a second plurality of feature values. More particularly, text-based features can be extracted from the description while remaining features may be ascertained using the description, as described herein.

The system then applies the machine learning model to the second plurality of feature values such that one or more scores are generated at 512. Thus, the model generates one or more scores that represent the input listing description. More particularly, a single score may represent the quality of the listing description. In some instances, the score may indicate the speed with which the property is likely to sell. The scores may be provided for display via a graphical user interface (GUI).

In some implementations, multiple sub-scores may be generated for a given listing description. Specifically, each feature may have a corresponding sub-score. In other implementations, a sub-score may be associated with several features.

The system may generate a new description using the one or more scores and/or at least a portion of the second plurality of feature values. The new description may be provided for display via a graphical user interface (GUI).

To generate the new description, a sub-score and/or associated feature value(s) may be applied to generate a portion of the new description. More particularly, if the sub-score is lower than a threshold value (e.g., between 1 and 3), a portion of the new description can be generated to increase the associated sub-score. However, if the sub-score is greater than a threshold value (e.g., between 3 and 5), the corresponding portion of the new description may be retained from the original description without modification.

In some implementations, words in the original description are replaced with other words designed to increase a particular sub-score. For example, a “bad word” may be replaced with a “good word.” In some implementations, the system may look up a bad word in a translation dictionary to identify suitable “good words.”

In some implementations, rather than generating a new description, a listing description summary is generated and provided via a GUI. The listing description summary is generated for the original description using generated score(s) and/or at least a portion of the second plurality of values. The listing description summary may include a summary of the deficiencies in the listing. More particularly, the summary can include one or more sub-scores and/or one or more of second plurality of feature values. Therefore, the listing description summary can include suggestions that may be useful in assisting a real estate agent or assistant in improving the description.

For example, a reading speed for a particular description may be 3 minutes and have a corresponding score of 2. A corresponding listing description summary may state that the description has a reading speed of 3 minutes and/or provide a hint that the description should be reduced in length. As another example, the summary may indicate that the overall sentiment is negative or neutral, and that words relaying a positive sentiment should be added. As yet another example, the summary may identify the bad words and/or good words in the description along with a suggestion to reduce or eliminate the bad words and/or increase the number of good words. The system may also look up the bad words in a translation dictionary to find suitable replacement “good words,” which may be provided in the summary.

In some implementations, the summary may indicate that the listing description does not include enough real estate features. More particularly, the system may ascertain that one or more feature words (e.g., bedroom, bathroom) are not present in the description. The summary may therefore state that the threshold minimum number of features has not been met or specifically list the features (e.g., bedrooms, bathrooms) that are missing from the description.

The summary may further identify typographical errors or other mistakes in the description. For example, the summary may identify the number of grammatical errors and/or may identify specific mistakes in the description.

As yet another example, the summary may identify the number of adjectives in the description. In addition, the summary may indicate that a threshold number of adjectives has not been met.

Any of the operations and techniques described in this application may be implemented as software code to be executed by a processor using any suitable computer language using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A method, comprising:
obtaining training data, the training data including a plurality of descriptions, each of the plurality of descriptions describing a corresponding property;
preparing the training data by labeling each description as “good” or “bad”;
extracting from the training data, for each of a plurality of features, a corresponding feature value of a first plurality of feature values, the plurality of features including a feature words count, number of adjectives, and grammatical mistake count;
training a machine learning model using the first plurality of feature values corresponding to the plurality of features, the machine learning model including a plurality of coefficients, each coefficient corresponding to one of the plurality of features;
obtaining data including a listing description of an item;
extracting for the listing description, for each of the plurality of features, a corresponding one of a second plurality of feature values;
applying the machine learning model to the second plurality of feature values such that one or more scores are generated for the listing description.

2. The method of claim 1, the plurality of features including a readability score.

3. The method of claim 1, the training data including a first group of descriptions and a second group of descriptions, the first group of descriptions being assigned a first label and the second group of descriptions being assigned a second label.

4. The method of claim 3, each of the first group of descriptions having an assigned score between 1 and 3, and each of the second group of descriptions having an assigned score between 3 and 5.

5. The method of claim 3, each of the plurality of descriptions being assigned to the first group or second group based, at least in part, on number of days the property is on the market prior to selling and a number of users that have saved the description.

6. The method of claim 1, wherein training the machine learning model includes performing supervised and semi-supervised learning.

7. The method of claim 1, each of the plurality of descriptions describing a real estate property, commercial real estate, or vehicle.

8. The method of claim 1, further comprising:
generating a new description using the one or more scores and the second plurality of feature values.

9. The method of claim 1, further comprising:
generating one or more description suggestions using the one or more scores and at least a portion of the second plurality of feature values;
providing a description summary including the description suggestions via a graphical user interface (GUI).

10. A non-transitory computer readable medium storing one or more programs configured for execution by a computer, the one or more programs comprising instructions for:
obtaining training data, the training data including a plurality of descriptions, each of the plurality of descriptions describing a corresponding property;
preparing the training data by labeling each description as “good” or “bad”;
extracting from the training data, for each of a plurality of features, a corresponding feature value of a first plurality of feature values, the plurality of features including a feature words count, number of adjectives, and grammatical mistake count;
training a machine learning model using the first plurality of feature values corresponding to the plurality of features, the machine learning model including a plurality of coefficients, each coefficient corresponding to one of the plurality of features;
obtaining data including a listing description of an item;
extracting for the listing description, for each of the plurality of features, a corresponding one of a second plurality of feature values;
applying the machine learning model to the second plurality of feature values such that one or more scores are generated for the listing description.

11. The non-transitory computer readable medium of claim 10, the training data including a first group of descriptions and a second group of descriptions, the first group of descriptions being assigned a first label and the second group of descriptions being assigned a second label.

12. The non-transitory computer readable medium of claim 11, each of the first group of descriptions having an assigned score between 1 and 3, and each of the second group of descriptions having an assigned score between 3 and 5.

13. The non-transitory computer readable medium of claim 11, each of the plurality of descriptions being assigned to the first group or second group based, at least in part, on number of days the property is on the market prior to selling and a number of users that have saved the description.

14. The non-transitory computer readable medium of claim 10, wherein training the machine learning model includes performing supervised and semi-supervised learning.
generating a new description using the one or more scores and the second plurality of feature values.

15. The non-transitory computer readable medium of claim 10, further comprising:
generating one or more description suggestions using the one or more scores and at least a portion of the second plurality of feature values;
providing a description summary including the description suggestions via a graphical user interface (GUI).

16. A system comprising:
one or more processors;
memory; and
one or more programs stored in the memory, the one or more programs comprising instructions for:
obtaining training data, the training data including a plurality of descriptions, each of the plurality of descriptions describing a corresponding property;
preparing the training data by labeling each description as “good” or “bad”;
extracting from the training data, for each of a plurality of features, a corresponding feature value of a first plurality of feature values, the plurality of features including a feature words count, number of adjectives, and grammatical mistake count;
training a machine learning model using the first plurality of feature values corresponding to the plurality of features, the machine learning model including a plurality of coefficients, each coefficient corresponding to one of the plurality of features;
obtaining data including a listing description of an item;
extracting for the listing description, for each of the plurality of features, a corresponding one of a second plurality of feature values;
applying the machine learning model to the second plurality of feature values such that one or more scores are generated for the listing description.

17. The system of claim 16, the training data including a first group of descriptions and a second group of descriptions, the first group of descriptions being assigned a first label and the second group of descriptions being assigned a second label.

18. The system of claim 17, each of the first group of descriptions having an assigned score between 1 and 3, and each of the second group of descriptions having an assigned score between 3 and 5.

19. The system of claim 17, each of the plurality of descriptions being assigned to the first group or second group based, at least in part, on number of days the property is on the market prior to selling and a number of users that have saved the description.

20. The system of claim 16, wherein training the machine learning model includes performing supervised and semi-supervised learning.
